(19) United States
(12) Patent Application Publication
(10) Pub. No.: US 2017/0044926 A1
(43) Pub. Date: Feb. 16, 2017

(54) METHOD FOR PRODUCING A VARIABLE TURBINE GEOMETRY OF AN EXHAUST GAS TURBOCHARGER

(71) Applicant: Bosch Mahle Turbo Systems GmbH & Co. KG, Stuttgart (DE)

(72) Inventor: Dirk Lummer, Ludwigsburg (DE)

(21) Appl. No.: 15/235,750

(22) Filed: Aug. 12, 2016

(30) Foreign Application Priority Data
Aug. 13, 2015 (DE) 10 2015 215 492.0

(51) Int. Cl. F01D 17/16; F02B 33/00; F02B 37/00

(52) U.S. Cl. CPC F01D 17/165; F02B 37/00; F02B 33/00; F05D 2220/40; F05D 2240/12; F05D 2230/60; F05D 2230/10; F05D 2250/311

(57) ABSTRACT

A method for producing a variable turbine geometry for an exhaust gas turbocharger may include arranging a first and a second guide vane support ring coaxially and axially at a distance from each other. The method may also include creating, by a boring process, at least one first guide vane bore in the first guide vane support ring and at least one second guide vane bore in the second guide vane support ring and aligned with the at least one first guide vane bore. The at least one first guide vane bore and the at least one second guide vane bore may be configured to adjustably receive a guide vane of the variable turbine geometry.

### CROSS REFERENCE TO RELATED APPLICATIONS

This application claims priority to German Application No. DE 10 2015 215 492.0, filed Aug. 13, 2015, the contents of which are hereby incorporated by reference in their entirety.

### TECHNICAL FIELD

The present invention concerns a method for producing a variable turbine geometry of an exhaust gas turbocharger.

Charging devices, such as exhaust gas turbochargers, can be equipped with a variable turbine geometry. The variable turbine geometry is outfitted with movable guide vanes, which can influence or change an inflow cross section of exhaust gases against the turbine wheel. Thanks to such a variable turbine geometry, it is thus possible to change the inflow of exhaust gas against the turbine wheel at the turbine side, so that by means of the variable turbine geometry the rotational speed of the turbine wheel and, thereby, the performance of the exhaust gas turbocharger can be influenced. At the compressor side, it is possible with a variable compressor geometry to influence the flow of air/exhaust gas produced by the compressor wheel. Hence, by using a variable turbine geometry, such a charging device can advantageously be adjusted specifically for the particular operating mode and supply an internal combustion engine connected to the charging device with an optimized flow of air/exhaust gas.

However, the drawback to the use of a variable turbine geometry is the presence of a large number of moving parts, for when moving parts are used there is also usually a mutual play between the individual components. Therefore, a highly precise positioning of the moving parts during the course of the fabrication of the variable turbine geometry is of special importance.

This holds particularly for the guide vanes of the variable turbine geometry, which are typically mounted in rotary manner on one or two so-called guide vane support rings.

In order to adjust the axial play of the guide vanes of the variable turbine geometry, EP 0 226 444 B1 recommends the use of spacing sleeves between the two guide vane support rings of the variable turbine geometry. Against this back-ground, DE 1 428 171 discloses a variable turbine geometry with double mounted guide vanes. In order to prevent a jamming of the guide vanes, U.S. 2010/0008766 A1 proposes arranging stepped spacing sleeves axially between the two guide vane support rings.

### SUMMARY

One problem which the present invention proposes to solve is to create an improved method for producing a variable turbine geometry.

This problem is solved by the subject-matter of the independent patent claims. Preferred embodiments are the subject-matter of the dependent patent claims.

In the method according to the invention for producing a variable turbine geometry for an exhaust gas turbocharger, in a first step a first and a second guide vane support ring are arranged coaxially and at a distance from each other. After this, using a suitable boring device, in the same boring process at least one first guide vane bore is created in the first guide vane support ring. By means of the same boring process, in addition a second guide vane bore is created aligned with this first guide vane bore. The two guide vane bores so produced in the guide vane support rings are used for the adjustable receiving of a guide vane of the variable turbine geometry. Of course, one such pair of guide vane bores can be created for each guide vane of the variable turbine geometry. Thanks to the producing of the two guide vane bores in the course of a single boring process, the positioning of the two guide vane bores can be kept to a minimum. This, in turn, allows a low-friction, rotatable mounting of the guide vanes, which has favorable impact on the wear of the guide vanes during operation of the variable turbine geometry. In particular, it is possible to prevent a jamming of the guide vanes, caused by too much lateral offset of the first guide vane bore from the second guide vane bore due to manufacturing tolerances.

In one advantageous modification of the invention, the method has an additional method step whereby at least one guide vane is arranged with ability to rotate between the two guide vane support rings. The arrangement of the at least one guide vane is such that the guide vane is received partly in the at least one first guide vane bore and partly in the second guide vane bore aligned with the first guide vane bore. Preferably the two axial end segments of a rotary spindle or rotary shaft which are opposite each other in the axial direction are received in the two guide vane bores. In this case, the axis of rotation is defined by the central longitudinal axis of the spindle or shaft, which extends parallel to the central longitudinal axis of the two guide vane support rings.

In order to make sure that no unwanted lateral relative movement between the two guide vane support rings in the course of the joint boring process for the producing of a pair of guide vane bores results in the first and second through bores not being aligned, it has proven to be advantageous in a preferred embodiment to receive and secure the two guide vane support rings being machined in a common holding device. In such a holding device the two guide vane support rings remain held during the making of the pairs of guide vane bores.

According to another advantageous modification of the invention, before or after performing step b) at least one first through bore is made in the first guide vane support ring and an additional second through bore aligned with this first through bore. The resulting through bores are designed to receive a fastening element, by means of which the two guide vane support rings can be fastened to a housing part, especially of a bearing housing or turbine housing of an exhaust gas turbo-charger. Since the two through bores are produced during the same boring process, here can also be just like the two above-described guide vane bores tolerances during the aligned orientation of the two through bores relative to each other kept low. This facilitates the precise fastening of the guide vane support rings to said housing part. The fastening means could be, say, a screw thread or a threaded pin or a threaded bolt. It is clear that not only a single first and second through bore, but also several such pairs of first and second through bore can be bored in order to fasten the two guide vane support rings of the variable turbine geometry to said housing part in a mechanically stable manner. Preferably, three first and second through bores are provided, which can be arranged in particular at an angle of 120° relative to each other in a top view looking down on the two guide vane support rings.

The guide vane support rings can remain preferably in the same holding device which is also used for the making of the guide vane bores for the making of said through bores.

Preferably, the method presented here can have a first additional method step whereby a centring sleeve is arranged between the two guide vane support rings such that this is aligned with the first and the second through bore. After this, in an additional second method step, a fastening element is inserted into the two additional through bores and into the centring sleeve. This is done in a way such that the fastening element reaches through the two through bores and reaches through the centring sleeve with radial play. After being placed through the two through bores/centring sleeve, the fastening element sticks out in the axial direction beyond the first guide vane support ring, so that it can be fastened to the housing part of the bearing housing or turbine housing. For this, once again, an external thread can be provided in the portion of the fastening element sticking out beyond the guide vane support ring. By means of the centring sleeve, the fastening element can be centred between the two guide vane support rings, which significantly enhances the accuracy of the orienting of the two guide vane support rings to each other and prevents a jamming of the guide vanes. By means of the fastening element, such as one in the manner of a fastening screw or a threaded pin/bolt, the two guide vane support rings can thus be positioned and also fastened especially precisely on the housing part of the bearing housing or turbine housing.

Especially preferably, a centring sleeve can be used which has a first axial end segment which passes along the axial direction of the spacing sleeve into an axial middle segment. Said axial middle segment passes in the axial direction into a second axial end segment, opposite the first axial end segment. A first radial step is formed on an outer circumferential surface of the centring sleeve in the transition region between the first axial end segment and the axial middle segment. Correspondingly, a second radial step is formed between the axial middle segment and the second axial end segment. The two radial steps are fashioned so that the radius of the centring sleeve is enlarged in the axial middle segment. With the help of its two radial steps, the centring sleeve additionally fulfils the function of a spacing element for adjusting the axial distance of the two guide vane support rings relative to each other.

Especially advisedly, said centring sleeve is arranged between the two guide vane support rings so that the first axial end segment is received in the first through bore and the second axial end segment is received in the second through bore. In this variant, the two guide vane support rings are braced in the axial direction against the axial middle segment in stable manner. In this way, the desired axial distance between the two guide vane support rings can be determined very precisely and adjusted in easy manner.

Also in an alternative preferred embodiment a centring sleeve is used, having a first axial end segment passing along the axial direction of the centring sleeve into an axial middle segment. Said axial middle segment also passes along the axial direction into a second axial end segment, opposite the first axial end segment. In this variant, however, the centring sleeve is arranged between the two guide vane support rings so that the first axial end segment is received in the first through bore and the second axial end segment in the second through bore. In addition, in the region of the middle segment of the centring sleeve there is arranged a spacing sleeve radially on the outside, against which the two guide vane support rings can be braced axially.

Especially advisedly, the fastening element can be configured as a screw thread or a bolt or pin, each with an external thread. Moreover, the first and/or second guide vane bore can preferably be designed as a through bore or a blind bore.

The invention moreover concerns a variable turbine geometry, especially one produced by means of the above presented method. The variable turbine geometry comprises a first guide vane support ring and a second guide vane support ring arranged coaxially and at a distance from the latter. In the first guide vane support ring there is present at least one first guide vane bore and in the second guide vane support ring at least one second guide vane bore aligned with the first guide vane bore. In the two guide vane bores each time there is mounted a guide vane which can rotate. Furthermore, in the first guide vane support ring there is present at least one first through bore and in the second guide vane support ring a second through bore aligned with the at least one first through bore. Each pair of first and second through bore is coordinated with a respective centring sleeve. The centring sleeve has a first axial end segment, which passes along an axial direction into an axial middle segment and from this into a second axial end segment, which in turn is opposite the first axial end segment. The centring sleeve is arranged between the two guide vane support rings such that the first axial end segment is received in the first through bore and the second axial end segment in the second through bore.

According to the invention, a fastening element is received in the two through bores and in the centring sleeve, which reaches through the two through bores and reaches through the centring sleeve with radial play. The fastening element sticks out in the axial direction beyond the first guide vane support ring for the fastening of the two guide vane support rings to a housing part. The centring sleeve serves to centre the two guide vane support rings relative to each other in order to prevent a jamming of the mounted guide vanes. Said centring is accomplished by the outer diameter of the centring sleeve. The inner diameter of the centring sleeve, on the other hand, is dimensioned so that a play is present between the fastening element and the centring sleeve. In this way, unwanted mechanical stresses which are caused by temperature fluctuations in the centring sleeve and fastening element during operation of the variable turbine geometry can be counteracted.

In one advantageous modification of the invention, on an outer circumferential surface of the centring sleeve in the transition region between the first axial end segment and the axial middle segment there is formed a first radial step and between the axial middle segment and the second axial end segment a second radial step. By means of the two radial steps, the radius of the centring sleeve is increased in the axial middle segment. This has the result that the centring sleeve in the axial middle segment has an increased sleeve thickness as compared to the axial end segments. In this way, the two axial end segments can be received in the respective through bores of the guide vane support rings, and the two guide vane support rings can be braced in the axial middle segment with increased sleeve thickness in the axial direction. In other words, in this variant the axial middle segment acts like a spacing element. Since instead of a separate spacing sleeve such a spacing function is already integrated in the centring sleeve, there is no need for a separate spacing sleeve. This leads to benefits in the mounting of the variable turbine geometry.

Alternatively to this, additionally to the centring sleeve, a separate spacing sleeve can be provided. Said spacing sleeve in this scenario is arranged in the region of the axial middle segment of the centring sleeve radially on the outside and next to the centring sleeve, being placed thereupon. The two guide vane support rings are axially braced against the spacing sleeve. In this variant, the centring sleeve serves to centre the two guide vane support rings on each other, in order to pre-vent a jamming of the mounted guide vanes. On the other hand, the spacing sleeve serves to ensure the desired axial distance between the two guide vane support rings. Since the two sleeves are realized as separate components, they can be mounted successively in the variable turbine geometry. This simplifies the mounting process in a not insignificant way. During assembly, one places a value on a reduction in the number of parts, but it is made possible by a dividing of the functions of “centring” and “spacing” between two components for each of them to be fabricated in very economical manner.

### BRIEF DESCRIPTION OF THE DRAWINGS

There are depicted, schematically each time

FIG. 1 in perspective representation, an example of a variable turbine geometry in a mounted state, produced by means of the production method according to the invention,

FIG. 2 the variable turbine geometry of FIG. 1 in a longitudinal section along the axial direction A of the guide vane support rings in the region of a guide vane,

FIG. 3 the variable turbine geometry of FIG. 1 in a longitudinal section along the axial direction A of the guide vane support rings in the region of two through bores for the fastening of the guide vane support rings on a housing part of an exhaust gas turbocharger, in which a single-piece design of a centring and spacing sleeve is used, i.e., the centring sleeve additionally takes on the function of a spacing element,

FIG. 4 a variant of the example of FIG. 3, in which a two-piece design of centring and spacing sleeve is used.

### DETAILED DESCRIPTION

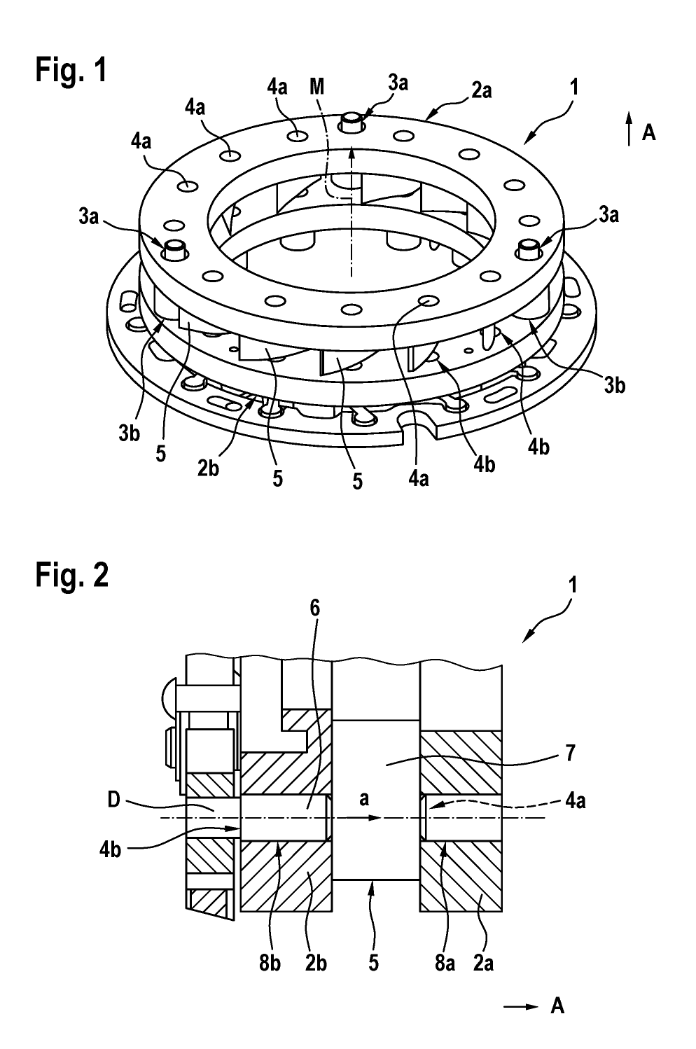

FIG. 1 shows in perspective representation an example of a variable turbine geometry 1 produced by means of the production method according to the invention in a mounted state. The variable turbine geometry 1 comprises a first guide vane support ring 2a and a second guide vane support ring 2b arranged coaxially to the latter and at an axial distance. In the first guide vane support ring 2a there are three first through bores 3a. In the second guide vane support ring 2b there are three second through bores 3b, each of the first through bores 3a being flush with a second through bore 3b coordinated with it. In variants of the example, this number can be different. In regard to a top view of the first guide vane support ring 2a, in its circumferential direction U, there are arranged two neighbouring first through bores 3a at an angle of 120° to each other.

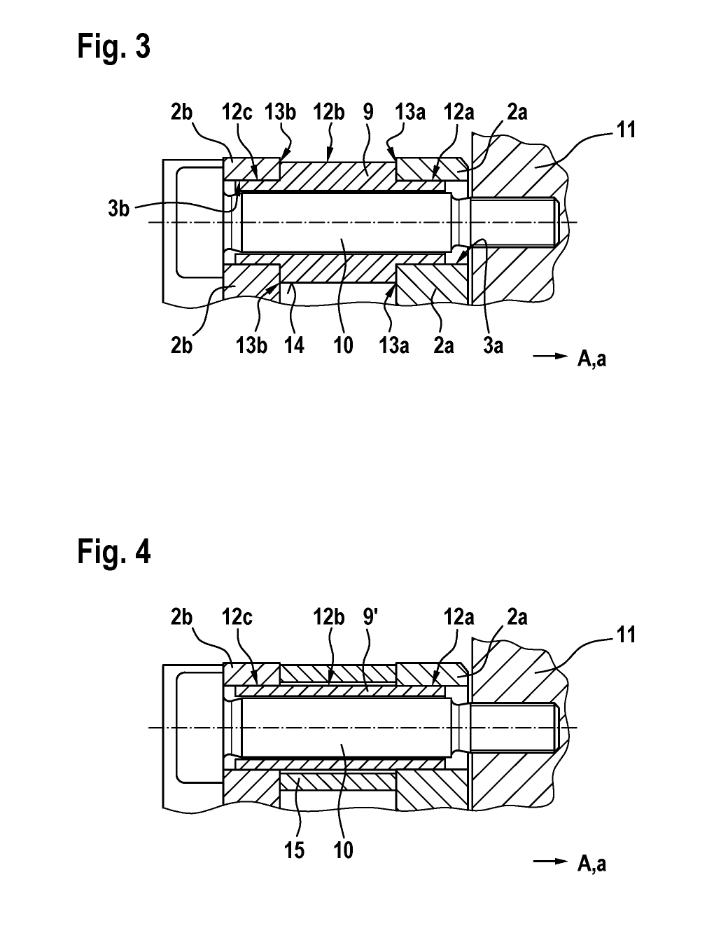

In order to make the through bores 3a, 3b of the variable turbine geometry 1, the two guide vane support rings 2a, 2b are arranged coaxially and at a distance from each other. Each of the first through bores 3a as well as the respective corresponding second through bore 3b is produced in each case by means of a suitable boring means in the course of a single boring process. This means that every first through bore 3a is exactly aligned with its corresponding second through bore 3b. Every first through bore 3a and its corresponding second through bore 3b is thus formed to receive a fastening element 10 positioned precisely in the two guide vane support rings 2a, 2b, by means of which the two guide vane support rings 3a, 3b can be fastened to a housing part 11 (for clarity shown only in FIGS. 3 and 4) of a bearing housing or a turbine housing.

Moreover, in the first guide vane support ring 2a there are arranged a plurality of first guide vane bores 4a. In the second guide vane support ring 2b there is pro-vided, for every first guide vane bore 4a of the first guide vane support ring 2a, a second guide vane bore 4b aligned with it. The first guide vane bores 4a are arranged with rotational symmetry relative to each other in regard to the central longitudinal axis M of the first guide vane support ring 2a. The same holds, mutatis mutandis, for the second guide vane bores 4b of the second guide vane support ring 2b. Axially between the second guide vane support rings 2a, 2b, and thus each time between one first guide vane bore 4a and one second guide vane bore 4b, there is arranged each time a guide vane 5 of the variable turbine geometry 1.

The first and second guide vane bores 4a, 4b can also be produced by a suitable boring means. For this, in the course of the same boring process in the first guide vane support ring 2a, at least one first guide vane bore 4a and a second guide vane bore 4b aligned with this first guide vane bore 4a are produced, so that the two guide vane bores 4a, 4b are designed for the adjustable receiving of said guide vanes 5. The guide vanes 5 can be arranged axially between the two guide vane support rings 2a, 2b such that each guide vane 5 can be turned relatively to the two guide vane support rings 2a, 2b and received each time in part in its corresponding first guide vane bore 4a and in the second guide vane bore 4b aligned with this first guide vane bore 4a. Thanks to the aligned arrangement of the two guide vane bores 4a, 4b, which are produced in the same boring step, the respective guide vane 5 can be received very precisely in the two guide vane bores 4a, 4b. An unwanted skewing of the guide vane 5 and, thus, an increased wear during operation can be largely or even entirely prevented in this way.

During the making of the through bores 3a, 3b and the guide vane bores 4a, 4b the two guide vane support rings 2a, 2b can be received and secured in a common holding device (not shown). In this way, it can be assured that the resulting tolerances in the aligned arrangement of the through bores 3a, 3b and the guide vane bores 4a, 4b relative to each other can be kept small, which enables an especially precise guiding of the guide vanes 5 in the guide vane bores 4a, 4b and of the fastening element 10 in the through bore 3a, 3b.

FIG. 2 shows the variable turbine geometry 1 of FIG. 1 in a longitudinal section along the axial direction A of the guide vane support rings 2a, 2b in the region of a guide vane 5. According to FIG. 2, each guide vane 5 comprises a spindle 6, which is arranged parallel to the axial direction A of the two guide vane support rings 2a, 2b, and a vane element 7 arranged firm against rotation on the spindle 6. Each guide vane 5 is able to turn relative to the two guide vane support rings 2a, 2b about an axis of rotation D defined by the central longitudinal axis of the spindle 6. The spindle 6 is received by its oppositely situated end segments 8a, 8b partly in the first or second guide vane bore 4a or 4b of the first or second guide vane support ring 2a, 2b, respectively.

FIG. 3 shows the variable turbine geometry 1 of FIG. 1 in a longitudinal section along the axial direction A of the guide vane support rings 2a, 2b in the region of two through bores 3a, 3b. One notices that a centring sleeve 9 is arranged between the guide vane support rings 2a, 2b, being aligned with the two through bores 3a, 3b. The centring sleeve 9 serves on the one hand as a spacing element between the two guide vane support rings 2a, 2b and on the other hand as a centring element for the centring of the two guide vane support rings 2a, 2b relative to each other. Furthermore, the centring sleeve 9 also serves to receive a fastening element 10 with radial play, in order to minimize or even entirely avoid a sideways load on the fastening element 10. By means of the fastening element 10, the two guide vane support rings 2a, 2b including the guide vane 5 can be fastened to a housing part 11 of a bearing housing or turbine housing of an exhaust gas turbocharger.

The centring sleeve 9 has a first axial end segment 12a, which passes along its axial direction A into an axial middle segment 12b and from this into a second axial end segment 12c opposite the first axial end segment 12a. The centring sleeve 9 is arranged between the two guide vane support rings 2a, 2b so that the first axial end segment 12a is received in the first through bore 3a and the second axial end segment 12c in the second through bore 3b. The two guide vane support rings 2a, 2b are braced axially against the axial middle segment 12b of the centring sleeve.

As FIG. 3 shows, on an outer circumferential surface 14 of the centring sleeve 9 a first radial step 13 is formed in the transition region between first axial end segment 12a and axial middle segment 12b. Between the axial middle segment 12b and the second axial end segment 12c there is formed a second radial step 13b. With the two radial steps 13a, 13b, an increasing of the radius R of the centring sleeve 9 in the axial middle segment 12b as compared to the two axial end segments 12a, 12c is accomplished.

FIG. 4 illustrates one variant of the example of FIG. 3. In the example of FIG. 4, the centring sleeve 9′ does not have the two radial steps 13a, 13b of the centring sleeve 9 of FIG. 3 as shown in FIG. 3. Instead, however, a spacing sleeve 15 is provided in addition to the centring sleeve 9′. The spacing sleeve 15 is arranged in the region of the axial middle segment 12b of the centring sleeve 9′, radially on the outside, at a distance from the centring sleeve 9′. The spacing sleeve 15 is arranged outside of the two through bores 3a, 3b axially between the two guide vane support rings 2a, 2b.

The spacing sleeve 15 acts on the two guide vane support rings 2a, 2b as a separate spacing element, for which the two guide vane support rings 2a, 2b are braced axially against the spacing sleeve 15. The centring sleeve 9′, on the other hand, serves solely to centre the two guide vane support rings 2a, 2b relative to each other and to receive the fastening element with play.

The fastening element 10, as shown in the example of FIGS. 3 and 4, can be designed as a screw. Alternatively to this, the fastening element 10 can also be designed in the way of a fastening bolt or fastening pin.

Preferably, the first and second guide vane bores 4a, 4b can be designed as through bore or one of the two bores as a blind bore.

1. A method for producing a variable turbine geometry for an exhaust gas turbocharger, comprising:
arranging a first and a second guide vane support ring coaxially and axially at a distance from each other; and
creating, by a boring process, at least one first guide vane bore in the first guide vane support ring and at least one second guide vane bore in the second guide vane support ring and aligned with the at least one first guide vane bore;
wherein the at least one first guide vane bore and the at least one second guide vane bore are configured to adjustably receive a guide vane of the variable turbine geometry.

2. A method according to claim 1, further comprising:
partly arranging the guide vane between the first and the second guide vane support rings such that the guide vane is received partly in the at least one first guide vane bore and partly in the at least one second guide vane bore aligned with the at least one first guide vane bore and is able to rotate relative to the first and the second guide vane support rings.

3. A method according to claim 1, wherein the first and the second guide vane support rings are received and secured in a common holding device, in which they are held at least during the creating of the at least one first guide vane bore and the at least one second guide vane bore.

4. A method according to claim 1, further comprising:
making, by a boring process, at least one first through bore in the first guide vane support ring and at least one second through bore in the second guide vane support ring and aligned with the at least one first through bore;
wherein the at least one first through bores and the at least one second through bore are designed to receive a fastener, by which the first and the second guide vane support rings are able to be fastened to a housing part.

5. A method according to claim 4, further comprising:
arranging a centring sleeve between the first and the second guide vane support rings and aligned with the at least one first through bore and the at least one second through bore; and
inserting the fastener into the at least one first through bores, the at least one second through bore, and the centring sleeve, such that the fastener has radial play and sticks out in an axial direction beyond the first guide vane support ring for fastening of the first and the second guide vane support rings to the housing part.

6. A method according to claim 5, wherein:
a the centring sleeve has a first axial end segment, which passes along the axial direction of the centring sleeve into an axial middle segment, and from the axial middle segment into a second axial end segment, opposite the first axial end segment; and
a first radial step is formed on an outer circumferential surface of the centring sleeve in a transition region between the first axial end segment and the axial middle segment and a second radial step is formed between the axial middle segment and the second axial end segment, such that an outer radius of the centring sleeve is larger in the axial middle segment than in either the first axial end segment or the second axial end segment.

7. A method according to claim 6, wherein the centring sleeve is arranged between the first and the second guide vane support rings so that the first axial end segment is received in the at least one first through bore and the second axial end segment is received in the at least one second through bore, and the first and the second guide vane support rings are braced in the axial direction against the axial middle segment.

8. A method according to claim 5, wherein:
the centring sleeve has a first axial end segment passing along the axial direction of the centring sleeve into an axial middle segment and from the axial middle segment into a second axial end segment, opposite the first axial end segment;
the centring sleeve is arranged between the first and the second guide vane support rings so that the first axial end segment is received in the at least one first through bore and the second axial end segment in the at least one second through bore, and
in a region of the axial middle segment of the centring sleeve there is arranged a spacing sleeve radially outside of the centring sleeve, the first and the second guide vane support rings are being braced axially against the spacing sleeve.

9. A method according to claim 4, wherein at least one of:
the fastener is configured as a screw thread or a bolt or pin; and
at least one of the at least one first guide vane bore and the at least one second guide vane bore is designed as one of a through bore or a blind bore.

10. A variable turbine geometry, comprising:
a first guide vane support ring and a second guide vane support ring arranged coaxially and at a distance from each other,
the first guide vane support ring including at least one first guide vane bore, the second guide vane support ring including at least one second guide vane bore aligned with the first guide vane bore. a guide vane rotatably mounted in the at least one first guide vane bore and the at least one second guide vane bore,
the first guide vane support ring further including at least one first through bore, and the second guide vane support ring further including at least one second through bore aligned with the at least one first through bore;
at least one centring sleeve, having a first axial end segment, which passes along an axial direction into an axial middle segment, and from the axial middle segment into a second axial end segment opposite the first axial end segment,
the centring sleeve is being arranged between the first and the second guide vane support rings such that the first axial end segment is received in the at least one first through bore and the second axial end segment in the at least one second through bore, and
a fastener received in the at least one first through bore, the at least one second through bores, and the centring sleeve, the fastener reaching through the at least one first through bore, the at least one second through bore and the centring sleeve, the fastener having radial play and sticking out in the axial direction beyond the first guide vane support ring for the fastening of the first and the second guide vane support rings to a housing part.

11. A variable turbine geometry according to claim 10, wherein on an outer circumferential surface of the centring sleeve in a transition region between the first axial end segment and the axial middle segment there is formed a first radial step, and between the axial middle segment and the second axial end segment there is formed a second radial step, such that an outer radius of the centring sleeve in the axial middle segment is increased larger than in either the first axial end segment or the second axial end segment, and the two guide vane support rings are axially braced against the axial middle segment.

12. A variable turbine geometry according to claim 10, further comprising a spacing sleeve arranged in a region of the axial middle segment of the centring sleeve radially outside of and adjacent to the centring sleeve, the first and the second guide vane support rings being braced axially against the spacing sleeve.

13. A method according to claim 2, wherein the first and the second guide vane support rings are received and secured in a common holding device, in which they are held at least during the creating of the at least one first guide vane bore and the at least one second guide vane bore.

14. A method according to claim 2, further comprising:
making, by a boring process, at least one first through bore in the first guide vane support ring and at least one second through bore in the second guide vane support ring and aligned with the at least one first through bore;
wherein the at least one first through bore and the at least one second through bore are designed to receive a fastener, by which the first and the second guide vane support rings are able to be fastened to a housing part.

15. A method according to claim 14, further comprising:
arranging a centring sleeve between the first and the second guide vane support rings and aligned with the at least one first through bore and the at least one second through bore; and
inserting the fastener into the at least one first through bore, the at least one second through bore, and the centring sleeve, such that the fastener has radial play and sticks out in an axial direction beyond the first guide vane support ring for fastening of the first and the second guide vane support rings to the housing part.

16. A method according to claim 15, wherein:
the centring sleeve has a first axial end segment, which passes along the axial direction of the centring sleeve into an axial middle segment, and from the axial middle segment into a second axial end segment opposite the first axial end segment;
a first radial step is formed on an outer circumferential surface of the centring sleeve in a transition region between the first axial end segment and the axial middle segment, and a second radial step is formed between the axial middle segment and the second axial end segment, such that an outer radius of the centring sleeve is larger in the axial middle segment than in either the first axial end segment or the second axial end segment; and
the centring sleeve is arranged between the first and the second guide vane support rings so that the first axial end segment is received in the at least one first through bore and the second axial end segment is received in the at least one second through bore, and the first and the second guide vane support rings are braced in the axial direction against the axial middle segment.

17. A method according to claim 15, wherein:
the centring sleeve has a first axial end segment passing along the axial direction of the centring sleeve into an axial middle segment, and from the axial middle segment into a second axial end segment opposite the first axial end segment;
the centring sleeve is arranged between the first and the second guide vane support rings so that the first axial end segment is received in the at least one first through bore and the second axial end segment in the at least one second through bore; and
in a region of the axial middle segment of the centring sleeve there is arranged a spacing sleeve radially outside of the centring sleeve, the first and the second guide vane support rings being braced axially against the spacing sleeve.

18. A method according to claim 3, further comprising:
making, by a boring process, at least one first through bore in the first guide vane support ring and at least one second through bore in the second guide vane support ring and aligned with the at least one first through bore;
wherein the at least one first through bore and the at least one second through bore are designed to receive a fastener, by which the first and the second guide vane support rings are able to be fastened to a housing part.

19. A method according to claim 5, wherein the fastener is configured as a screw thread or a bolt or pin.

20. A method according to claim 5, wherein at least one of the at least one first guide vane bore and the at least one second guide vane bore is designed as one of a through bore or a blind bore.
